(19) United States
(12) Patent Application Publication
(10) Pub. No.: US 2010/0290975 A1
(43) Pub. Date: Nov. 18, 2010

(54) HOT SOLIDS PROCESS SELECTIVELY OPERABLE FOR COMBUSTION PURPOSES AND GASIFICATION PURPOSES

(75) Inventors: Herbert E. ANDRUS, JR., Granby, CT (US); John H. CHIU, West Hartford, CT (US); Gregory N. LILJEDAHL, Tariffville, CT (US); Paul R. THIBEAULT, Windsor, CT (US); Carl R. BOZZUTO, Enfield, CT (US); Corinne BEAL, Voisins le Bretonneux (FR); Michal T. BIALKOWSKI, Untersiggenthal (CH); Andreas BRAUTSCH, Wurenlingen (CH); Laurent MAGHDISSIAN, Orsay (FR); Michel VANDYCKE, Gambais (FR)

Correspondence Address: ALSTOM Power Inc., 200 Great Pond Drive, P.O. Box 500, WINDSOR, CT, 06095, US

(73) Assignee: ALSTOM Technology Ltd, Baden (CH)

(21) Appl. No.: 12/749,166

(22) Filed: Mar. 29, 2010

Related U.S. Application Data
(60) Provisional application No. 61/165,042, filed on Mar. 31, 2009.

(51) Int. Cl. C10J 3/46; C01B 31/20; C01B 31/18; C01B 3/02

(52) U.S. Cl. 423/418.2; 48/197 R; 423/437.1; 423/648.1

(57) ABSTRACT

A hot solids process operable selectively for combustion purposes and gasification purposes wherein a pre-identified product is selected from a group of products to be generated through the use of the hot solids process. Based on the nature of the pre-identified product, which is to be generated through the use of the hot solids process, a specific fuel from which the pre-identified product is capable of being derived is selected from a group of fuels. Then, from a group of reactors there is selected a first reactor, which is operable for generating in the first reactor the pre-identified product as an output from the first reactor. Thereafter, from a group of reactors, there is selected a second reactor, which is operable for effecting in the second reactor the conversion of air and of a predetermined carrier selected from a group of carriers to produce a predefined output from the second reactor.

### CROSS-REFERENCE TO RELATED APPLICATIONS

This application claims priority to copending U.S. provisional application entitled HOT SOLIDS PROCESS SELECTIVELY OPERABLE FOR COMBUSTION PURPOSES AND GASIFICATION PURPOSES having U.S. Ser. No. 61/165,042, filed Mar. 31, 2009 which is entirely incorporated herein by reference.

### TECHNICAL FIELD

This invention relates generally to hot solids processes that are capable of being selectively operated either for combustion processes or for gasification purposes. More particularly, the present invention relates to such a hot solids process wherein both a pre-identified product, which is to be generated through the use of such a hot solids process, is selected from a pre-established group of products, and a specific fuel from which the pre-identified product is capable of being derived through the use of such a hot solids process is selected from a pre-established group of fuels based on the nature of the pre-identified product that is generated.

### BACKGROUND

The World today faces a critical challenge as all nations strive to satisfy basic human requirements—food, shelter, clothing and work—that are so dependent on adequate supplies of energy. The great increase in the use of energy has been met mostly by fossil fuels—primarily, coal, oil and gas. The belief is that environmental concerns, security of supply, and economic impacts must all be balanced as the demand for energy continues to increase. Real economic growth and energy use nevertheless still remain inextricably linked.

While the quest for ultimate solutions to provide adequate energy supplies continues, near term, interim solutions must be considered for meeting the immediate growth in demand for energy. Technological improvements in the mining, drilling, moving, processing, and using of fossil fuels can, of course, stretch energy resource reserves, as can a determined effort at conservation of energy. Similarly, the utilization of advanced clean fossil fuel technologies involving the employment of various forms of hot solids processes such as, by way of exemplification and not limitation, fossil fuel gasification, fluidized-bed combustion, or hybrid combustion-gasification fossil fuel technologies, are capable of having the effect of that of widening the use of the World's vast fossil fuel resources.

In accordance with the mode of operation of electrical power generation systems, as is well known to most, the steam that is produced by the steam generators, which are employed in such electrical power generation systems, from the combustion of fossil fuel therein is designed to be employed in steam turbines. Such steam, which commonly is both at a high temperature and at a high pressure is expanded in the aforementioned steam turbine in order to thereby effect a rotation of the steam turbine. Such rotation of the steam turbine in turn is operative in a known manner to cause a generator that is suitably operatively connected to the steam turbine to rotate as well. Then, when the generator undergoes such rotation, a conductor is made to move through a magnetic field thereby causing an electric current to be generated. The aforedescribed mode of operation is fundamentally the basis upon which electrical power generation systems continue to be predicated even to this day.

In an effort to realize higher efficiencies for electrical power generation systems, attempts have been known to have been made to increase the temperatures and the pressures at which the steam generators that are employed in such electrical power generation system are capable of being operated. Such efforts to date have resulted in steam generators being supplied commercially for employment in electrical power generation systems that are capable of being operated at subcritical pressure conditions or that are capable of being operated at supercritical pressure conditions. Improvements in the strength of the materials from which such steam generators, which are intended for employment in electrical power generation systems, are designed to be constructed have permitted such materials, and thus such steam generators, to be operated both at such higher temperatures and at such higher pressures.

Discussing further the advanced clean fossil fuel technologies to which reference has been had above previously wherein various forms of hot solids processes are employed, and in particular to that of fossil fuel gasification technologies, attention is first directed in this connection, by way of exemplification and not limitation, to U.S. Pat. No. 2,602,809, which issued on Jul. 8, 1952 to The M. W. Kellogg Company. The teachings of U.S. Pat. No. 2,602,809 are considered to be representative of an exemplification of an early development in the continuing development of fossil fuel gasification technologies of the type wherein hot solids processes are employed. To this end, in accordance with the teachings thereof, the teachings of U.S. Pat. No. 2,602,809 are directed to a process, which is said to be particularly suited for the gasification of low-grade solid carbon-containing materials. More specifically, insofar as the mode of operation of the process to which the teachings of U.S. Pat. No. 2,602,809 are directed is concerned, the solid carbon-containing materials are designed to be oxidized in order to convert such solid carbon-containing materials to carbon oxides by virtue of the indirect oxidation thereof with air in such a manner that the nitrogen of the air does not contaminate the product gas. Such gasification of the solid carbon-containing materials is accomplished by virtue of the alternate oxidation and reduction of a fluidized metal oxide. According to the teachings of U.S. Pat. No. 2,602,809, solid fuels are subjected to being converted to gases as a consequence of the contacting by a metal oxide with finely-divided solid carbon-containing materials under conditions such as to cause the metal oxide to be reduced and the carbon of the solid fuel to be oxidized to carbon oxides, with the metal oxide being the principal source of oxygen that is required for the oxidation of the carbon. Then, after the metal oxide has been reduced, the reduced metal oxide is subjected to being reoxidized whereupon the process cycle is capable of being repeated once again.

With further regard to the fossil fuel gasification technologies of the advanced clean fossil fuel technologies to which reference has been had above previously wherein various forms of hot solids processes are employed, attention is next directed herein, by way of exemplification and not limitation, to U.S. Pat. No. 4,602,573, which issued on Jul. 29, 1986 to Combustion Engineering, Inc. The teachings of U.S. Pat. No. 4,602,573 are considered to be representative of an exemplification of a further development in the continuing evolution of fossil fuel gasification technologies of the type wherein hot solids processes are employed. To this end, in accordance with the teachings thereof, the teachings of U.S. Pat. No. 4,602,573 are stated to be directed to a method of gasifying and combusting a carbonaceous fuel and, more particularly to an integrated process wherein a sulfur and nitrogen-bearing carbonaceous fuel is gasified to produce a carbon monoxide-rich low BTU fuel gas that is designed to be subsequently combusted with additional carbonaceous fuel in a steam generator. More specifically, insofar as the mode of operation of the process to which the teachings of U.S. Pat. No. 4,602,573 are directed is concerned, a first portion of sulfur and nitrogen-bearing carbonaceous fuel is gasified in a gasification reactor in a reducing atmosphere of air to produce a hot, char-containing, carbon monoxide-rich fuel gas having a low BTU content. Thereafter, a sulfur capturing material is introduced into the gasification reactor so that the gasifying of the carbonaceous fuel is carried out in the presence of the sulfur capturing material whereby a substantial portion of the sulfur in the carbonaceous fuel being gasified is captured by the sulfur capturing material.

Attention will next be directed herein further to the advanced clean fossil fuel technologies to which reference has been had above previously wherein various forms of hot solids processes are employed and in particular to that of fluidized-bed combustion technologies. Thus, more specifically, attention is therefore directed in this connection, by way of exemplification and not limitation, to U.S. Pat. No. 4,111,158, which issued on Sep. 5, 1978 to Metallgesellschaft Aktiengesellschaft. The teachings of U.S. Pat. No. 4,111,158 are considered to be representative of an exemplification of an early development in the continuing development of the fluidized-bed combustion technologies of the type wherein hot solids processes are employed. To this end, in accordance with the teachings thereof, the teachings of U.S. Pat. No. 4,111,158 are stated to be directed to a method of and an apparatus for carrying out an exothermic process in which a solid feed contains a combustible such as, for example, carbonaceous or sulfurous compounds. Continuing, insofar as the mode of operation of the method of and the apparatus for to which the teachings of U.S. Pat. No. 4,111,158 are directed is concerned, the combustible compounds of the solid feed are designed to be burned under approximately stoichiometric conditions in a fluidized bed. Thereafter, the solids, which are produced as a consequence of such burning of the combustible compounds of the solid feed and which are withdrawn from the fluidized bed, are caused to be recycled back to the fluidized bed, while the heat that is produced from such burning of the combustible compounds of the solid feed is available to be recovered.

Regarding further the fluidized-bed combustion technologies of the advanced clean fossil fuel technologies to which reference has been had above previously wherein various forms of hot solids processes are employed, attention is next directed herein, by way of exemplification and not limitation, to U.S. Pat. No. 5,533,471, which issued on Jul. 9, 1996 to A. Ahlstrom Corporation. The teachings of U.S. Pat. No. 5,533,471 are considered to be representative of an exemplification of a further development in the continuing evolution of fluidized-bed combustion technologies of the type wherein hot solids processes are employed. To this end, in accordance with the teachings thereof, the teachings of U.S. Pat. No. 5,533,471 are stated to be directed to a system and to a method that allow the temperature of the fluidized bed reactor to be controlled efficiently, allowing adequate heat transfer surface area for cooling of solid materials. More specifically, insofar as the mode of operation of the system and of the method to which the teachings of U.S. Pat. No. 5,533,471 are directed is concerned, a circulating (fast) fluidized bed and a bubbling (slow) fluidized bed are utilized. Continuing, these two (2) fluidized beds are mounted adjacent each other with first and second interconnections between them, typically with the fluidizing gas introducing grid of the bubbling fluidized bed being below that of the circulating fluidized bed. Because the bubbling fluidized bed has a substantially constant density throughout, with a clear demarcation line at the top thereof, the first interconnection is provided above the top of the bubbling fluidized bed so that the pressure and density conditions between the two (2) fluidized beds result in a flow of particles from the circulating fluidized bed to the bubbling fluidized bed through the first interconnection. However, since the average density in the bubbling fluidized bed is higher than the density in the circulating fluidized bed, the pressure and density conditions cause the particles after treatment in the bubbling fluidized bed (e.g., after the cooling of the particles therein) to return to the circulating fluidized bed through the second interconnection.

Discussing further the advanced clean fossil fuel technologies to which reference has been had above previously wherein various forms of hot solids processes are employed, and in particular that of hybrid combustion-gasification technologies, attention is first directed in this connection, by way of exemplification and not limitation, to U.S. Pat. No. 4,272,399, which issued on Jun. 9, 1981 to the Monsanto Company. The teachings of U.S. Pat. No. 4,272,399 are considered to be representative of an exemplification of an early development in the continuing evolution of the hybrid combustion-gasification technologies of the type wherein hot solids processes are employed. To this end, in accordance with the teachings thereof, the teachings of U.S. Pat. No. 4,272,399 are stated to be directed to a unified process for producing high purity synthesis gas from carbon-containing materials. More specifically, insofar as the mode of operation of the unified process to which the teachings of U.S. Pat. No. 4,272,399 are directed is concerned, a metal-oxygen containing material, which can be characterized as a heat and oxygen carrier and which can be referred to generally as an oxidant, is used as the transfer agent of oxygen and heat for oxidatively gasifying carbon-containing material. Continuing, steam, carbon dioxide, synthesis gas or mixtures thereof are employed to fluidize and transport the oxidant through an up-flow, co-current system. Thus, in accordance with the mode of operation of the subject unified process, synthesis gas is first oxidized and heated by the oxidant to form water and carbon dioxide in an oxidant reducing zone prior to contact of the oxidant and gases with the carbon-containing material in a gasifying zone. In addition, the carbon-containing materials are oxidized to predominantly carbon dioxide and hydrogen in a manner such that the nitrogen contained in the air does not contaminate the product synthesis gas. Furthermore, the gasification of the carbon-containing material is accomplished by the alternate oxidation and reduction of a fluidized oxidant. Then, after such gasification, the reduced oxidant, which may be in the form of the elemental metal or lower oxidized state is re-oxidized in an oxidizing zone and the cycle is then repeated.

Regarding further the hybrid combustion-gasification technologies of the advanced clean fossil fuel technologies to which reference has been had above previously wherein various forms of hot solids processes are employed, attention is next directed herein, by way of exemplification and not limitation, to U.S. Pat. No. 7,083,658, which issued on Aug. 1, 2006 to ALSTOM Technology Ltd. The teachings of U.S. Pat. No. 7,083,658 are considered to be representative of an exemplification of a further development in the continuing evolution of hybrid combustion-gasification technologies of the type wherein hot solids processes are employed. To this end, in accordance with the teachings thereof, the teachings of U.S. Pat. No. 7,083,658 are stated to be directed to apparatus utilizing fossil fuels, biomass, petroleum coke, or any other carbon bearing fuel to produce hydrogen for power generation, which minimizes or eliminates the release of carbon dioxide (CO2). More specifically, insofar as the mode of operation of the apparatus to which the teachings of U.S. Pat. No. 7,083,658 are directed is concerned, a gasifier is provided for producing a gas product from a carbonaceous fuel, which comprises a first chemical process loop including an exothermic oxidizer reactor and an endothermic reducer reactor. Continuing, the exothermic oxidizer reactor has a CaS inlet, a hot air inlet and a CaSO4/waste gas outlet. Whereas, the endothermic reducer reactor has a CaSO4 inlet in fluid communication with the exothermic oxidation reactor CaSO4/waste gas outlet, a CaS/gas product outlet in fluid communication with the exothermic oxidizer reactor CaS inlet, and a materials inlet for receiving the carbonaceous fuel. Moreover, CaS is oxidized in air in the exothermic oxidizer reactor to form hot CaSO4, which is discharged to the endothermic reducer reactor. Furthermore, hot CaSO4 and carbonaceous fuel that is received in the endothermic reducer reactor undergo an endothermic reaction utilizing the heat content of the CaSO4 with the carbonaceous fuel stripping the oxygen from the CaSO4 to form CaS and the gas product. Thereafter, the CaS is discharged to the exothermic oxidizer reactor, and with the gas product being discharged from the first chemical process loop.

It is, therefore, an object of the present invention to provide a hot solids process that is operable selectively for combustion purposes and for gasification purposes.

It is also an object of the present invention to provide such a hot solids process that is capable of being employed to generate a pre-identified product.

It is another object of the present invention to provide such a hot solids process wherein such a pre-identified product is selectable from a group of products that includes gaseous CO2, liquid CO2, CO/H2 syngas, gaseous H2, liquid H2, gaseous CO and liquid CO.

It is still another object of the present invention to provide such a hot solids process wherein based on the nature of such a pre-identified product that is to be generated a specific fuel from which such a pre-identified product is capable of being derived is selectable for employment in such a hot solids process.

A further object of the present invention is to provide such a hot solids process wherein such a specific fuel is selectable from a group of fuels that includes solid carbonaceous fuels, liquid carbonaceous fuels, petro waste, refuse derived fuels, and biomass.

A still further object of the present invention is to provide such a hot solids process wherein the reactors employed therein are selected from a group of reactors that includes a fixed bed reactor, a bubbling bed reactor, a circulating bed reactor, a transport reactor, and an entrained bed reactor.

Yet another object of the present invention is to provide such a hot solids process that is relatively inexpensive to provide, is relatively uncomplicated to employ, and is characterized by its great versatility insofar as the products that are capable of being generated through the use thereof.

### SUMMARY OF THE INVENTION

In accordance with the present invention a hot solids process is provided that is operable selectively for combustion purposes and for gasification purposes. The subject hot solids process comprises in accordance with the present invention the following steps. A pre-identified product that is to be generated through the use of the hot solids process of the present invention is selected from a group of products that includes at least two of gaseous CO2, liquid CO2, CO/H2 syngas, gaseous H2, liquid H2, gaseous CO, and liquid CO. Based on the nature of the pre-identified product that is to be generated through the use of the hot solids process of the present invention a specific fuel from which the pre-identified product is capable of being derived is selected from a group of fuels that includes at least two of solid carbonaceous fuels, liquid carbonaceous fuels, petro waste, refuse derived fuel, and biomass. Furthermore, a first reactor that is operable for purposes of generating the pre-identified product as an output of the first reactor is selected from a group of reactors that includes at least two of a fixed bed reactor, a bubbling bed reactor, a circulating bed reactor, a transport reactor, and an entrained bed reactor, and a second reactor, which is operable for purposes of effecting the conversion in the second reactor of air and a predetermined carrier selected from a group of carriers that includes calcium-based carriers and metal-based carriers in order to thereby produce as a predetermined output of the second reactor from the converted air and predetermined carrier, is selected from a group of reactors that includes a fixed bed reactor, a bubbling bed reactor, a circulating bed reactor, a transport reactor, and an entrained bed reactor. Continuing, in accordance with the mode of operation of the hot solids process of the present invention, air and the predetermined carrier are supplied as inputs to the second reactor, a conversion of the air and of the predetermined carrier is effected in the second reactor to produce a predetermined output from the second reactor, the specific fuel and the predetermined output from the second reactor are supplied as inputs to the first reactor, a conversion of the specific fuel and of the predetermined output from the second reactor is effected in the first reactor in order to thereby produce the pre-identified product that is to be generated through the use of the hot solids process of the present invention, and the discharge from the first reactor of the pre-identified product is effected.

In accordance with a first exemplary embodiment of the mode of operation of the hot solids process of the present invention, the pre-identified product that is to be generated through the use of the hot solids process of the present invention is CO2, and the specific fuel that is to be combusted for purposes of effecting the conversion thereof in order to derive therefrom the pre-identified product, which in accordance with this first exemplary embodiment is CO2, is a solid carbonaceous fuel. With further reference to this first exemplary embodiment of the mode of operation of the hot solids process of the present invention, preferably, by way of exemplification and not limitation, each first reactor and each second reactor that is selected for use in accordance with this first exemplary embodiment of the mode of operation of the hot solids process of the present invention is a circulating bed reactor.

In accordance with a second exemplary embodiment of the mode of operation of the hot solids process of the present invention, the pre-identified product that is to be generated through the use of the hot solids process of the present invention is CO/H2 syngas, and the specific fuel that is to be combusted for purposes of effecting the conversion thereof in order to derive therefrom the pre-identified product, which in accordance with this second exemplary embodiment is CO/H2 syngas, is a solid carbonaceous fuel. With further reference to this second exemplary embodiment of the mode of operation of the hot solids process of the present invention, preferably, by way of exemplification and not limitation, each first reactor and each second reactor that is selected for use in accordance with this second exemplary embodiment of the mode of operation of the hot solids process of the present invention is a circulating bed reactor. In accordance with a third exemplary embodiment of the mode of operation of the hot solid process of the present invention, the pre-identified product that is to be generated through the use of the hot solids process of the present invention is H2, and the specific fuel that is to be combusted for purposes of effecting the conversion thereof in order to derive therefrom the pre-identified product, which in accordance with this third exemplary embodiment is H2, is a solid carbonaceous fuel. With further reference to this third exemplary embodiment of the mode of operation of the hot solids process of the present invention, preferably, by way of exemplification and not limitation, each first reactor and each second reactor that is selected for use in accordance with this third exemplary embodiment of the mode of operation of the hot solids process of the present invention is a circulating bed reactor.

In accordance with a fourth exemplary embodiment of the mode of operation of the hot solids process of the present invention, the pre-identified product that is to be generated through the use of the hot solids process of the present invention is both H2 and CO2, and the specific fuel that is to be combusted for purposes of effecting the conversion thereof in order to derive therefrom the pre-identified product, which in accordance with this fourth exemplary embodiment is both H2 and CO2, is a solid carbonaceous fuel. With further reference to this fourth exemplary embodiment of the mode of operation of the hot solids process of the present invention, preferably, by way of exemplification and not limitation, each first reactor and each second reactor that is selected for use in accordance with this fourth exemplary embodiment of the mode of operation of the hot solids process of the present invention is a circulating bed reactor.

The above described and other features are exemplified by the following figures and detailed description.

### BRIEF DESCRIPTION OF THE DRAWINGS

FIG. 1 is a schematic diagram of a hot solids process that functions in accordance with the present invention;

FIG. 2 is a schematic diagram of a first exemplary embodiment of the mode of operation of a hot solids process that functions in accordance with the present invention;

FIG. 3 is a schematic diagram of a second exemplary embodiment of the mode of operation of a hot solids process that functions in accordance with the present invention;

FIG. 4 is a schematic diagram of a third exemplary embodiment of the mode of operation of a hot solids process that functions in accordance with the present invention; and

FIG. 5 is a schematic diagram of a fourth exemplary embodiment of the mode of operation of a hot solids process that functions in accordance with the present invention.

### DETAILED DESCRIPTION

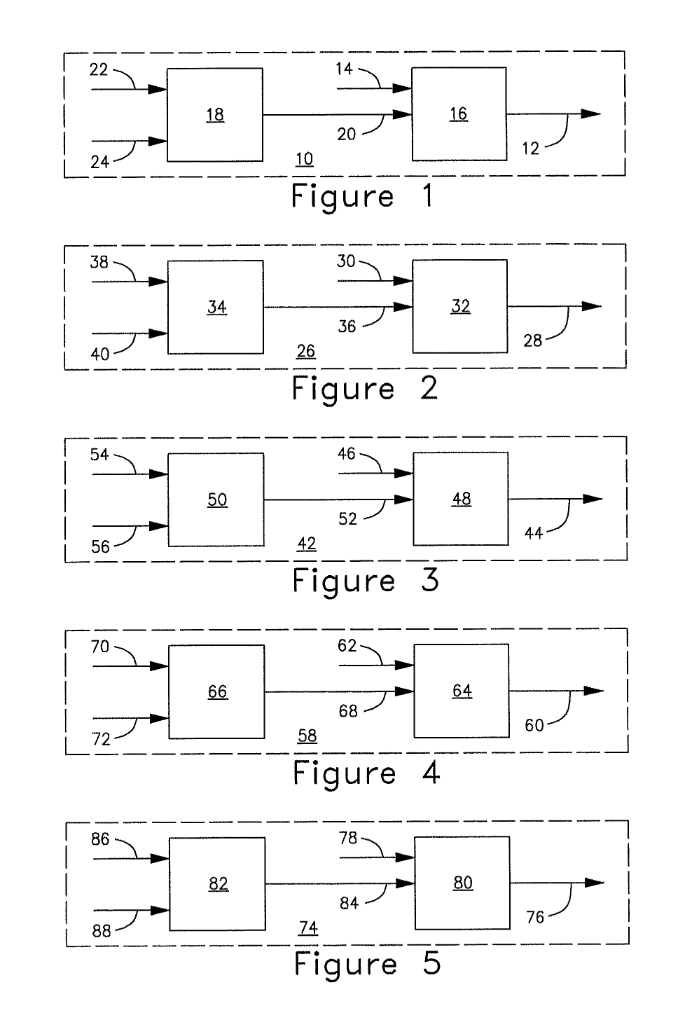

Referring now to FIG. 1 of the drawings, there is depicted therein a schematic diagram of a hot solids process, generally denoted by the reference numeral 10 in FIG. 1 of the drawings, that is operable in accordance with the present invention for purposes of generating a pre-identified product, which is denoted by the arrow 12 in FIG. 1 of the drawings, that is selectable from a group of products that includes at least two of gaseous CO2, liquid CO2, CO/H2 syngas, gaseous H2, liquid H2, gaseous CO, and liquid CO. In accordance with the mode of operation of the hot solids process 10 of the present invention, which is schematically depicted in FIG. 1 of the drawings, a specific fuel, which is denoted by the arrow 14 in FIG. 1 of the drawings, is selected from a group of fuels that includes at least two of solid carbonaceous fuels, liquid carbonaceous fuels, petro waste, refuse derived fuel, and biomass based on the nature of the pre-identified product 12 that is to be generated through the use of the hot solids process 10 of the present invention.

With further reference to FIG. 1 of the drawings, a first reactor, which is denoted generally by the reference numeral 16 in FIG. 1, and a second reactor, which is denoted generally by the reference numeral 18 in FIG. 1, are employed in the hot solids process 10 in accordance with the present invention. Each one of the first reactor 16 and of the second reactor 18 is designed, in accordance with the present invention, to be selectable from a group of reactors that includes at least two of a fixed bed reactor, a bubbling bed reactor, a circulating bed reactor, a transport reactor, and an entrained bed reactor.

Continuing, in accordance with a preferred mode of operation of the hot solids process 10 of the present invention, the first reactor 16 is designed to be operable for purposes of generating the pre-identified product 12 as an output of the first reactor 16, and the second reactor 18 is designed to be operable for purposes of producing a predefined output, which is denoted by the arrow 20 in FIG. 1 of the drawings. More specifically, the predefined output 20, which is produced in the second reactor 18, results from the conversion in the second reactor 18 of air, and with the latter air being denoted by the arrow 22 in FIG. 1 of the drawings, and a predetermined carrier, and with the latter predetermined carrier being denoted by the arrow 24 in FIG. 1 of the drawings. The predetermined carrier 24, in accordance with the present invention, is designed to be selectable from a group of carriers that includes calcium-based carriers and metal-based carriers. The air 22 and the predetermined carrier 24 are both designed, in accordance with the mode of operation of the hot solids process 10 of the present invention, to be supplied as inputs to the second reactor 18, while the predefined output 20, which is produced in the second reactor 18, is designed, in accordance with the mode of operation of the hot solids process 10 of the present invention, to be an output from the second reactor 18 that is supplied therefrom as an input to the first reactor 16.

As will be best understood with reference to FIG. 1 of the drawings, the hot solids process 10 of the present invention, as depicted schematically in FIG. 1 of the drawings, encompasses the following steps. The pre-identified product 12 that is to be generated through the use of the hot solids process 10 of the present invention is designed to be selected from the group of products that includes gaseous CO2, liquid CO2, CO/H2 syngas, gaseous H2, liquid H2, gaseous CO, and liquid CO. Based on the nature of the pre-identified product 12 that is to be generated through the use of the hot solids process 10 of the present invention, the specific fuel 14 from which the pre-identified product 12 is capable of being derived is designed to be selected from the group of fuels that includes solid carbonaceous fuels, liquid carbonaceous fuels, petro waste, refuse derived fuel, and biomass. Continuing, in accordance with the steps of the hot solids process 10 of the present invention, next the first reactor 16, which is operable for purposes of generating through the use of the hot solids process 10 of the present invention the pre-identified product 12 as an output from the first reactor 16, is designed to be selected from the group of reactors that includes a fixed bed reactor, a bubbling bed reactor, a circulating bed reactor, a transport reactor, and an entrained bed reactor. Thereafter, the second reactor 18, which is operable in accordance with the present invention for purposes of effecting the conversion of the air 22 and the predetermined carrier 24 that is selected from the group of carriers, which includes calcium-based carriers and metal-based carriers, in order to thereby produce the predefined output 20 from the second reactor 18, is designed to be selected from the group of reactors that includes a fixed bed reactor, a bubbling bed reactor, a circulating bed reactor, a transport reactor, and an entrained bed reactor. The air 22 and the predetermined carrier 24, in accordance with the mode of operation of the hot solids process 10 of the present invention, are each designed to be supplied as inputs to the second reactor 18, such that the conversion of the air 22 and of the predetermined carrier 24 is then capable of being effected in the second reactor 18, in order to thereby produce from the conversion of the air 22 and of the predetermined carrier 24, the predefined output 20 from the second reactor 18. In turn, the predefined output 20 and the specific fuel 14 are, in accordance with the mode of operation of the hot solids process 10 of the present invention, each supplied as inputs to the first reactor 16. Within the first reactor 16, the predefined output 20 from the second reactor 18 and the specific fuel 14 are then, in accordance with the mode of operation of the hot solids process 10 of the present invention, converted in order to thereby generate in the first reactor 16 the pre-identified product 12, whereupon the pre-identified product 12 is designed to be suitably discharged from the first reactor 16.

Reference will next be had herein to FIG. 2 of the drawings wherein there is depicted therein a schematic diagram of a first exemplary embodiment, generally denoted by the reference numeral 26 in FIG. 2 of the drawings, of the mode of operation of the hot solids process 10 of the present invention that is operable, in accordance with the present invention, for purposes of generating a pre-identified product wherein such pre-identified product preferably is selected from the group of products that includes gaseous CO2, liquid CO2, CO/H2 syngas, gaseous H2, liquid H2, gaseous CO, and liquid CO, to be, by way of exemplification and not limitation, CO2, and with the latter CO2 being denoted by the arrow 28 in FIG. 2 of the drawings. In accordance with the first exemplary embodiment 26 of the mode of operation of the hot solids process 10 of the present invention that is depicted in FIG. 2 of the drawings, a specific fuel, wherein such specific fuel preferably is selected, based on the nature of the pre-identified product 28, which is to be generated, in accordance with the first exemplary embodiment 26 of the mode of operation of the hot solids process 10 of the present invention being CO2, from the group of fuels that includes solid carbonaceous fuels, liquid carbonaceous fuels, petro waste, refuse derived fuel, and biomass, to be, by way of exemplification and not limitation, a solid carbonaceous fuel, and with the latter solid carbonaceous fuel being denoted by the arrow 30 in FIG. 2 of the drawings.

With further reference to the first exemplary embodiment 26 of the mode of operation of the hot solids process 10 of the present invention that is depicted in the schematic diagram, which is illustrated in FIG. 2 of the drawings, a first reactor, wherein such first reactor preferably is selected from the group of reactors that includes a fixed bed reactor, a bubbling bed reactor, a circulating bed reactor, a transport reactor, and an entrained bed reactor, to be, by way of exemplification and not limitation, a circulating bed reactor, and with the latter circulating bed reactor being denoted generally by the reference numeral 32 in FIG. 2 of the drawings, and a second reactor, wherein such second reactor preferably is selected from the group of reactors that includes a fixed bed reactor, a bubbling bed reactor, a circulating bed reactor, a transport reactor, and an entrained bed reactor, to be, by way of exemplification and not limitation, a circulating bed reactor, and with the latter circulating bed reactor being denoted generally by the reference numeral 34 in FIG. 2 of the drawings, are designed to be employed in the first exemplary embodiment 26 of the mode of operation of the hot solids process 10 of the present invention, which is depicted in FIG. 2 of the drawings. The first circulating bed reactor 32, in accordance with the first exemplary embodiment 26 of the mode of operation of the hot solids process 10 of the present invention, which is depicted in FIG. 2 of the drawings, is designed to be operable for purposes of generating therewithin the pre-identified product 28, which in this instance is designed to be selected to be, by way of exemplification and not limitation, CO2, as an output of the first circulating bed reactor 32. Such generation of the pre-identified CO2 product 28 preferably, by way of exemplification and not limitation, is effected in the first circulating bed reactor 32 in accordance with following chemical equations: 4C (solid carbonaceous fuel)+CaSO4+Heat→4CO+CaS; 8H (solid carbonaceous fuel)+CaSO4+Heat→CaS+4H2O; H2O+C (solid carbonaceous fuel)+Heat→H2+CO; and CO+H2O→H2+CO2. Whereas, the second circulating bed reactor 34, in accordance with the first exemplary embodiment of the mode of operation of the hot solids process 10 of the present invention, which is depicted in FIG. 2 of the drawings, is designed to be operable for purposes of producing a predefined output, and with the latter predefined output being denoted by the arrow 36 in FIG. 2 of the drawings. Such predefined output 36, in accordance with the first exemplary embodiment 26 of the mode of operation of the hot solids process 10 of the present invention, which is depicted in FIG. 2 of the drawings, that is produced in the second circulating bed reactor 34, results from the conversion in the second circulating bed reactor 34 of air, and with the latter air being denoted by the arrow 38 in FIG. 2 of the drawings, and of a predetermined carrier wherein such predetermined carrier, which is denoted by the arrow 40 in FIG. 2 of the drawings, is designed to be selected from a group of carriers that includes calcium-based carriers and metal-based carriers. Insofar as the first exemplary embodiment 26 of the mode of operation of the hot solids process 10 of the present invention, which is depicted in FIG. 2 of the drawings, is concerned, the predetermined carrier 40 may consist of either the calcium-based carrier CaS or the metal-based carrier Me. In the case wherein the predetermined carrier 40, for purposes of the first exemplary embodiment 26 of the hot solids process 10 of the present invention, which is depicted in FIG. 2 of the drawings, is selected to be the calcium-based carrier CaS, then the predefined output 36, which results from the conversion in the second circulating bed reactor 34 of the air 38 and of the predetermined CaS calcium-based carrier 40, comprises CaSO4. Such conversion of the air 38 and of the predetermined CaS calcium-based carrier 40 preferably is designed to be effected, by way of exemplification and not limitation, in the second circulating bed reactor 34, in accordance with the following chemical equation: CaS+2O2→CaSO4+Heat. Whereas, in the case wherein the predetermined carrier, for purposes of the first exemplary embodiment 26 of the hot solids process 10 of the present invention, which is depicted in FIG. 2 of the drawings, is selected to be the metal-cased carrier Me, then the predefined output 36, which results from the conversion in the second circulating bed reactor 34 of the air 38 and of the predetermined Me metal-based carrier 40, comprises MeO.

As will be best understood with reference to FIG. 2 of the drawings, the first exemplary embodiment 26 of the mode of operation of the hot solids process 10 of the present invention, as depicted schematically in FIG. 2 of the drawings, encompasses the following steps. The pre-identified CO2 product 28, which is to be generated through the use of the first exemplary embodiment 26 of the mode of operation of the hot solids process 10 of the present invention, is designed to be selected from the group of products that includes gaseous CO2, liquid CO2, CO/H2 syngas gaseous H2, liquid H2, gaseous CO, and liquid CO. Based on the nature of the pre-identified CO2 product 28, which is to be generated through the use of the first exemplary embodiment 26 of the mode of operation of the hot solids process 10 of the present invention, the specific solid carbonaceous fuel 30 from which the pre-identified CO2 product 28 is capable of being derived is designed to be selected from the group of fuels that includes solid carbonaceous fuels, liquid carbonaceous fuels, petro waste, refuse derived fuels, and biomass. Continuing, in accordance with the steps of the first exemplary embodiment 26 of the hot solids process 10 of the present invention, next the first circulating bed reactor 32, which is operable for purposes of generating through the use of the first exemplary embodiment 26 of the mode of operation of the hot solids process 10 of the present invention the pre-identified CO2 product 28 as an output from the first circulating bed reactor 32, is designed to be selected from the group of reactors that includes a fixed bed reactor, a bubbling bed reactor, a circulating bed reactor, a transport reactor, and an entrained bed reactor. Thereafter, the second circulating bed reactor 34 that is operable in accordance with the first exemplary embodiment 26 of the mode of operation of the hot solids process 10 of the present invention, which is depicted schematically in FIG. 2 of the drawings, for purposes of effecting the conversion of the air 38 and of either the predetermined CaS calcium-based carrier 40 or the predetermined Me metal-based carrier 40, whichever may be selected for use from the group of carriers that includes calcium-based carriers and metal-based carriers, in order to thereby produce, either the predefined CaSO4 output 36 in the case of the predetermined CaS calcium-based carrier 40 or the predefined MeO output 36 in the case of the predetermined Me metal-based carrier 40, from the second circulating bed reactor 34, is designed to be selected from the group of reactors that includes a fixed bed reactor, a bubbling bed reactor, a circulating bed reactor, a transport reactor, and an entrained bed reactor. The air 38 and the predetermined CaS calcium-based carrier 40 or the predetermined Me metal-based carrier 40, whichever may be selected for use from the group of carriers, are each designed, in accordance with the first exemplary embodiment 26 of the mode of operation of the hot solids process 10 of the present invention, which is schematically depicted in FIG. 2 of the drawings, to be supplied as inputs to the second circulating bed reactor 34, such that the conversion of the air 38 and of the predetermined CaS calcium-based carrier 40 or the predetermined Me metal-based carrier 40, whichever one of these two carriers is being employed, is then designed to be effected in the second circulating bed reactor 34, in order to thereby produce from the conversion of the air 38 and of the predetermined CaS calcium-based carrier 40 or from the conversion of the air 38 and of the predetermined Me metal-based carrier 40, the predefined CaSO4 output 36 and the predefined MeO output 36, respectively, from the second circulating bed reactor 34. The predefined CaSO4 output 36 or the predefined MeO output 36, whichever may be produced, and the specific solid carbonaceous fuel 30 are designed, in accordance with the first exemplary embodiment 26 of the mode of operation of the hot solids process 10 of the present invention, which is schematically depicted in FIG. 2 of the drawings, to be supplied as inputs to the first circulating bed reactor 32. Within the first circulating bed reactor 32, the predefined CaSO4 output 36 or the predefined MeO output 36, whichever may be produced, and the specific solid carbonaceous fuel 30 are then, in accordance with the first exemplary embodiment 26 of the mode of operation of the hot solids process 10 of the present invention, which is schematically depicted in FIG. 2 of the drawings, converted in order to thereby generate in the first circulating bed reactor 32 the pre-identified CO2 product 28, and with the pre-identified CO2 product 28 thereafter being designed to be suitably discharged from the first circulating bed reactor 32.

Reference will next be had herein to FIG. 3 of the drawings wherein there is depicted therein a schematic diagram of a second exemplary embodiment, generally denoted by the reference numeral 42 in FIG. 3 of the drawings, of the mode of operation of the hot solids process 10 of the present invention, which is operable, in accordance with the present invention, for purposes of generating a pre-identified product, wherein such pre-identified product preferably is selected from the group of products that includes gaseous CO2, liquid CO2, CO/H2 syngas, gaseous H2, liquid H2, gaseous CO, and liquid CO, to be, by way of exemplification and not limitation, CO/H2 syngas, and with the latter CO/H2 syngas being denoted by the arrow 44 in FIG. 3 of the drawings. In accordance with the second exemplary embodiment 42 of the mode of operation of the hot solids process 10 of the present invention, which is depicted in FIG. 3 of the drawings, a specific fuel, wherein such specific fuel preferably is selected, based on the nature of the pre-identified CO/H2 syngas product 44 that is to be generated in accordance with the second exemplary embodiment 42 of the mode of operation of the hot solids process 10 of the present invention being CO/H2 syngas, from the group of fuels that includes solid carbonaceous fuels, liquid carbonaceous fuels, petro waste, refuse derived fuels, and biomass, to be, by way of exemplification and not limitation, a solid carbonaceous fuel, and with the latter solid carbonaceous fuel being denoted by the arrow 46 in FIG. 3 of the drawings.

With further reference to the second exemplary embodiment 42 of the mode of operation of the hot solids process 10 of the present invention, which is depicted in the schematic diagram that is illustrated in FIG. 3 of the drawings, a first reactor, wherein such first reactor preferably is selected from the group of reactors that includes a fixed bed reactor, a bubbling bed reactor, a circulating bed reactor, a transport reactor, and an entrained bed reactor, to be, by way of exemplification and not limitation, a circulating bed reactor, and with the latter circulating bed reactor being denoted generally by the reference numeral 48 in FIG. 3 of the drawings, and a second reactor, wherein such second reactor preferably is selected from the group of reactors that includes a fixed bed reactor, a bubbling bed reactor, a circulating bed reactor, a transport reactor, and an entrained bed reactor, to be, by way of exemplification and not limitation, a circulating bed reactor, and with the latter circulating bed reactor being denoted generally by the reference numeral 50 in FIG. 3 of the drawings, are designed to be employed in the second exemplary embodiment 42 of the mode of operation of the hot solids process 10 of the present invention, which is schematically depicted in FIG. 3 of the drawings. The first circulating bed reactor 48, in accordance with the second exemplary embodiment 42 of the mode of operation of the hot solids process 10 of the present invention, which is schematically depicted in FIG. 3 of the drawings, is designed to be operable for purposes of generating therewithin the pre-identified product 44, which in this instance is selected to be CO/H2 syngas, as an output from the first circulating bed reactor 48. Whereas, the second circulating bed reactor 50, in accordance with the second exemplary embodiment 42 of the mode of operation of the hot solids process 10 of the present invention, which is schematically depicted in FIG. 3 of the drawings, is designed to be operable for purposes of producing a predefined output, and with the latter predefined output being denoted by the arrow 52 in FIG. 3 of the drawings. Such predefined output 52, in accordance with the second exemplary embodiment 42 of the mode of operation of the hot solids process 10 of the present invention, which is schematically depicted in FIG. 3 of the drawings, that is produced in the second circulating bed reactor 50, results from the conversion in the second circulating bed reactor 50 of air, and with the latter air being denoted by the arrow 54 in FIG. 3 of the drawings, and of a predetermined carrier, wherein such predetermined carrier, which is denoted by the arrow 56 in FIG. 3 of the drawings, preferably is selected from a group of carriers that includes calcium-based carriers and metal-based carriers, to be, by way of exemplification and not limitation, a calcium-based carrier. The conversion of the air 54 and of the predetermined calcium-based carrier 56, which is effected in the second circulating bed reactor 50, is designed to be operative to produce therefrom the predefined calcium-based output 52.

As will be best understood with reference to FIG. 3 of the drawings, the second exemplary embodiment 42 of the mode of operation of the hot solids process 10 of the present invention, as depicted schematically in FIG. 3 of the drawings, encompasses the following steps. The pre-identified CO/H2 syngas product 44, which is to be generated through the use of the second exemplary embodiment 42 of the mode of operation of the hot solids process 10 of the present invention, is designed to be selected from the group of products that includes gaseous CO2, liquid CO2, CO/H2 syngas, gaseous H2, liquid H2, gaseous CO, and liquid CO. Based on the nature of the pre-identified CO/H2 syngas product 44, which is to be generated through the use of the second exemplary embodiment 42 of the mode of operation of the hot solids process 10 of the present invention, the specific solid carbonaceous fuel 46, from which the pre-identified CO/H2 syngas product 44 is capable of being derived, is selected from the group of fuels that includes solid carbonaceous fuels, liquid carbonaceous fuels, petro waste, refuse derived fuels, and biomass. Continuing, in accordance with the steps of the second exemplary embodiment 42 of the mode of operation of the hot solids process 10 of the present invention, next the first circulating bed reactor 48, which is operable for purposes of generating through the use of the second exemplary embodiment 42 of the mode of operation of the hot solids process 10 of the present invention the pre-identified CO/H2 syngas product 44 as an output from the first circulating bed reactor 48, is designed to be selected from the group of reactors that includes a fixed bed reactor, a bubbling bed reactor, a circulating bed reactor, a transport reactor, and an entrained bed reactor. Thereafter, the second circulating bed reactor 50 that is operable, in accordance with the second exemplary embodiment 42 of the mode of operation of the hot solids process 10 of the present invention, which is depicted schematically in FIG. 3 of the drawings, for purposes of effecting the conversion of the air 54 and of the predetermined calcium-based carrier 56 in order to thereby produce therefrom the predefined calcium-based output 52, is designed to be selected from the group of reactors that includes a fixed bed reactor, a bubbling bed reactor, a circulating bed reactor, a transport reactor, and an entrained bed reactor. The air 54 and the predetermined calcium-based carrier 56, in accordance with the second exemplary embodiment 42 of the mode of operation of the hot solids process 10 of the present invention, which is schematically depicted in FIG. 3 of the drawings, are each designed to be supplied as inputs to the second circulating bed reactor 50, such that the conversion of the air 54 and of the predetermined calcium-based carrier 56 is then designed to be effected in the second circulating bed reactor 50, in order to thereby produce from the conversion of the air 54 and of the predetermined calcium-based carrier 56, the predefined calcium-based output 52 from the second circulating bed reactor 50. The predefined calcium-based output 52 and the specific solid carbonaceous fuel 46 are, in accordance with the second exemplary embodiment 42 of the mode of operation of the hot solids process 10 of the present invention, which is schematically depicted in FIG. 3 of the drawings, designed to be supplied as inputs to the first circulating bed reactor 48. Within the first circulating bed reactor 48, the predefined calcium-based output 52 and the specific solid carbonaceous fuel 46 are then, in accordance with the second exemplary embodiment 42 of the hot solids process 10 of the mode of operation of the present invention, which is schematically depicted in FIG. 3 of the drawings, converted, in order to thereby generate therefrom in the first circulating bed reactor 48, the pre-identified CO/H2 syngas product 44, whereupon the pre-identified CO/H2 syngas product 44 is thereafter designed to be suitably discharged from the first circulating bed reactor 48.

Reference will next be had herein to FIG. 4 of the drawings, wherein there is depicted therein a schematic diagram of a third exemplary embodiment, generally denoted by the reference numeral 58 in FIG. 4 of the drawings, of the mode of operation of the hot solids process 10 of the present invention, which is operable, in accordance with the present invention, for purposes of generating a pre-identified product, wherein such pre-identified product preferably is selected from the group of products that includes gaseous CO2, liquid CO2, CO/H2 syngas, gaseous H2, liquid H2, gaseous CO, and liquid CO, to be, by way of exemplification and not limitation, H2, and with the latter H2 being denoted by the arrow 60 in FIG. 4 of the drawings. In accordance with the third exemplary embodiment 58 of the mode of operation of the hot solids process 10 of the present invention, which is depicted in FIG. 4 of the drawings, a specific fuel, wherein such specific fuel preferably is selected, based on the nature of the pre-identified H2 product 60, which is to be generated in accordance with the third exemplary embodiment 58 of the mode of operation of the hot solids process 10 of the present invention, being H2, from the group of fuels that includes solid carbonaceous fuels, liquid carbonaceous fuels, petro waste, refuse derived fuels, and biomass, to be, by way of exemplification and not limitation, a solid carbonaceous fuel, and with the latter solid carbonaceous fuel being denoted by the arrow 62 in FIG. 4 of the drawings.

With further reference to the third exemplary embodiment 58 of the mode of operation of the hot solids process 10 of the present invention, which is depicted in the schematic diagram that is illustrated in FIG. 4 of the drawings, a first reactor, wherein such first reactor preferably is designed to be selected from the group of reactors that includes a fixed bed reactor, a bubbling bed reactor, a circulating bed reactor, a transport reactor, and an entrained bed reactor, to be, by way of exemplification and not limitation, a circulating bed reactor, and with the latter circulating bed reactor being denoted generally by the reference numeral 64 in FIG. 4 of the drawings, and a second reactor, wherein such second reactor preferably is designed to be selected from the group of reactors that includes a fixed bed reactor, a bubbling bed reactor, a circulating bed reactor, a transport reactor, and an entrained bed reactor, to be, by way of exemplification and not limitation, a circulating bed reactor, and with the latter circulating bed reactor being denoted generally by the reference numeral 66 in FIG. 4 of the drawings, are designed to be employed in the third exemplary embodiment 58 of the mode of operation of the hot solids process 10 of the present invention, which is schematically depicted in FIG. 4 of the drawings. The first circulating bed reactor 64, in accordance with the third exemplary embodiment 58 of the mode of operation of the hot solids process 10 of the present invention, which is schematically depicted in FIG. 4 of the drawings, is designed to be operable, for purposes of generating therewithin the pre-identified product 60, which in this instance is selected to be H2, as an output from the first circulating bed reactor 64. Whereas, the second circulating bed reactor 66, in accordance with the third exemplary embodiment 58 of the mode of operation of the hot solids process 10 of the present invention, which is schematically depicted in FIG. 4 of the drawings, is designed to be operable, for purposes of producing, a predefined output, and with the latter predefined outlet being denoted by the arrow 68 in FIG. 4 of the drawings. Such predefined output 68, in accordance with the third exemplary embodiment 58 of the mode of operation of the hot solids process 10 of the present invention that is schematically depicted in FIG. 4 of the drawings, which is produced in the second circulating bed reactor 66, results from the conversion in the second circulating bed reactor 66 of air, and with the latter air being denoted by the arrow 70 in FIG. 4 of the drawings, and of a predetermined carrier, wherein such predetermined carrier, which is denoted by the arrow 72 in FIG. 4 of the drawings, preferably is designed to be selected from the group of carriers that includes calcium-based carriers and metal-based carriers, to be, by way of exemplification and not limitation, a calcium-based carrier. The conversion of the air 70 and of the predetermined calcium-based carrier 72, which is effected in the second circulating bed reactor 66, is designed to be operative to produce therefrom the predefined calcium-based output 68.

As will be best understood with reference to FIG. 4 of the drawings, the third exemplary embodiment 58 of the mode of operation of the hot solids process 10 of the present invention, as depicted schematically in FIG. 4 of the drawings, encompasses the following steps. The pre-identified 142 product 60, which is to be generated through the use of the third exemplary embodiment 58 of the mode of operation of the hot solids process 10 of the present invention, is selected from the group of products that includes gaseous CO2, liquid CO2, CO/H2 syngas, gaseous H2, liquid H2, gaseous CO, and liquid CO. Based on the nature of the pre-identified H2 product 60, which is to be generated through the use of the third exemplary embodiment 58 of the mode of operation of the hot solids process 10 of the present invention, the specific solid carbonaceous fuel 62, from which the pre-identified H2 product 60 is capable of being derived, is selected from the group of fuels that includes solid carbonaceous fuels, liquid carbonaceous fuels, petro waste, refuse derived fuels, and biomass. Continuing, in accordance with the steps of the third exemplary embodiment 58 of the mode of operation of the hot solids process 10 of the present invention, next the first circulating bed reactor 64, which is operable for purposes of generating through the use of the third exemplary embodiment 58 of the mode of operation of the hot solids process 10 of the present invention the pre-identified H2 product 60 as an output from the first circulating bed reactor 64, is designed to be selected from the group of reactors that includes a fixed bed reactor, a bubbling bed reactor, a circulating bed reactor, a transport reactor, and an entrained bed reactor. Thereafter, the second circulating bed reactor 66, which is operable, in accordance with the third exemplary embodiment 58 of the mode of operation of the hot solids process 10 of the present invention that is depicted schematically in FIG. 4 of the drawings, for purposes of effecting the conversion of the air 70 and of the predetermined calcium-based carrier 72 in order to thereby produce therefrom the predefined calcium-based output 68, is designed to be selected from the group of reactors that includes a fixed bed reactor, a bubbling bed reactor, a circulating bed reactor, a transport reactor, and an entrained bed reactor. The air 70 and the predetermined calcium-based carrier 72, in accordance with the third exemplary embodiment 58 of the mode of operation of the hot solids process 10 of the present invention, which is schematically depicted in FIG. 4 of the drawings, are each designed to be supplied as inputs to the second circulating bed reactor 66, such that the conversion of the air 70 and of the predetermined calcium-based carrier 72 is then designed to be effected in the second circulating bed reactor 66, in order to thereby produce from the conversion of the air 70 and of the predetermined calcium-based carrier 72 the predefined calcium-based output 68 from the second circulating bed reactor 66. The predefined calcium-based output 68 and the specific solid carbonaceous fuel 62 are, in accordance with the third exemplary embodiment of the mode of operation of the hot solids process 10 of the present invention, which is schematically depicted in FIG. 4 of the drawings, designed to be supplied as inputs to the first circulating bed reactor 64. Within the first circulating bed reactor 64, the predefined calcium-based output 68 and the specific solid carbonaceous fuel 62 are then, in accordance with the third exemplary embodiment 58 of the hot solids process 10 of the mode of operation of the present invention, which is schematically depicted in FIG. 4 of the drawings, designed to be converted, in order to thereby generate therefrom in the first circulating bed reactor 64 the pre-identified H2 product 60, whereupon the pre-identified H2 product 60 is thereafter designed to be suitably discharged from the first circulating bed reactor 64.

Reference will next be had herein to FIG. 5 of the drawings wherein there is depicted therein a schematic diagram of a fourth exemplary embodiment, generally denoted by the reference numeral 74 in FIG. 5 of the drawings, of the mode of operation of the hot solids process 10 of the present invention, which is operable, in accordance with the present invention, for purposes of generating a pre-identified product, wherein such pre-identified product preferably is designed to be selected from the group of products that includes gaseous CO2, liquid CO2, CO/H2 syngas, gaseous H2, liquid H2, gaseous CO, and liquid CO, to be, by way of exemplification and not limitation, CO, and with the latter CO being denoted by the arrow 76 in FIG. 5 of the drawings. In accordance with the fourth exemplary embodiment 74 of the mode of operation of the hot solids process 10 of the present invention, which is depicted in FIG. 5 of the drawings, a specific fuel, wherein such specific fuel preferably is designed to be selected, based on the nature of the pre-identified CO product 76 that is to be generated in accordance with the fourth exemplary embodiment 74 of the mode of operation of the hot solids process 10 of the present invention being CO, from the group of fuels that includes solid carbonaceous fuels, liquid carbonaceous fuels, petro waste, refuse derived fuels, and biomass, to be, by way of exemplification and not limitation, a solid carbonaceous fuel, and with the latter solid carbonaceous fuel being denoted by the arrow 78 in FIG. 5 of the drawings.

With further reference to the fourth exemplary embodiment 74 of the mode of operation of the hot solids process 10 of the present invention, which is depicted in the schematic diagram that is illustrated in FIG. 5 of the drawings, a first reactor, wherein such first reactor preferably is designed to be selected from the group of reactors that includes a fixed bed reactor, a bubbling bed reactor, a circulating bed reactor, a transport reactor, and an entrained bed reactor, to be, by way of exemplification and not limitation, a circulating bed reactor, and with the latter circulating bed reactor being denoted generally by the reference numeral 80 in FIG. 5 of the drawings, and a second reactor, wherein such second reactor preferably is designed to be selected from the group of reactors that includes a fixed bed reactor, a bubbling bed reactor, a circulating bed reactor, a transport reactor, and an entrained bed reactor, to be, by way of exemplification and not limitation, a circulating bed reactor, and with the latter circulating bed reactor being denoted generally by the reference numeral 82 in FIG. 5 of the drawings, are designed to be employed in the fourth exemplary embodiment 74 of the mode of operation of the hot solids process 10 of the present invention, which is schematically depicted in FIG. 5 of the drawings. The first circulating bed reactor 80, in accordance with the fourth exemplary embodiment 74 of the mode of operation of the hot solids process 10 of the present invention, which is schematically depicted in FIG. 5 of the drawings, is designed to be operable, for purposes of generating therewithin, the pre-identified product 76, which in this instance is selected to be CO, as an output of the first circulating bed reactor 80. Whereas, the second circulating bed reactor 82, in accordance with the fourth exemplary embodiment 74 of the mode of operation of the hot solids process 10 of the present invention, which is schematically depicted in FIG. 5 of the drawings is designed to be operable for purposes of producing a predefined output, and with the latter predefined output being denoted by the arrow 84 in FIG. 5 of the drawings. Such predefined output 84, in accordance with the fourth exemplary embodiment 74 of the mode of operation of the hot solids process 10 of the present invention, which is schematically depicted in FIG. 5 of the drawings, that is produced in the second circulating bed reactor 82, results from the conversion in the second circulating bed reactor 82 of air, with the latter air being denoted by the arrow 86 in FIG. 5 of the drawings, and of a predetermined carrier, wherein such predetermined carrier, which is denoted by the arrow 88 in FIG. 5 of the drawings, preferably is designed to be selected from a group of carriers that includes calcium-based carriers and metal-based carriers, to be, by way of exemplification and not limitation, a calcium-based carrier. The conversion of the air 86 and of the predetermined calcium-based carrier 88 that is effected in the second circulating bed reactor 82 is designed to be operative to produce therefrom the predefined calcium-based output 84.

As will be best understood with reference to FIG. 5 of the drawings, the fourth exemplary embodiment 74 of the mode of operation of the hot solids process 10 of the present invention, as depicted schematically in FIG. 5 of the drawings, encompasses the following steps. The pre-identified CO product 76, which is to be generated through the use of the fourth exemplary embodiment 74 of the mode of operation of the hot solids process 10 of the present invention, is designed to be selected from the group of products that includes gaseous CO2, liquid CO2, CO/H2 syngas, gaseous H2, liquid H2, gaseous CO, and liquid CO. Based on the nature of the pre-identified CO product 76, which is to be generated through the use of the fourth exemplary embodiment 74 of the mode of operation of the hot solids process 10 of the present invention, the specific solid carbonaceous fuel 78, from which the pre-identified CO product 76 is capable of being derived, is designed to be selected from the group of fuels that includes solid carbonaceous fuels, liquid carbonaceous fuels, petro waste, refuse derived fuels, and biomass. Continuing, in accordance with the steps of the fourth exemplary embodiment 74 of the mode of operation of the hot solids process 10 of the present invention, next the first circulating bed reactor 80, which is operable for purposes of generating, through the use of the fourth exemplary embodiment 74 of the mode of operation of the hot solids process 10 of the present invention, the pre-identified CO product 76 as an output from the first circulating bed reactor 80, is designed to be selected from the group of reactors that includes a fixed bed reactor, a bubbling bed reactor, a circulating bed reactor, a transport reactor, and an entrained bed reactor. Thereafter, the second circulating bed reactor 82 that is operable in accordance with the fourth exemplary embodiment 74 of the mode of operation of the hot solids process 10 of the present invention, which is depicted schematically in FIG. 5 of the drawings, for purposes of effecting the conversion of the air 86 and of the predetermined calcium-based carrier 88 in order to thereby produce therefrom the predefined calcium-based output 84, is designed to be selected from the group of reactors that includes a fixed bed reactor, a bubbling bed reactor, a circulating bed reactor, a transport reactor, and an entrained bed reactor. The air 86 and the predetermined calcium-based carrier 88, in accordance with the fourth exemplary embodiment 74 of the mode of operation of the hot solids process 10 of the present invention, which is schematically depicted in FIG. 5 of the drawings, are each designed to be supplied as inputs to the second circulating bed reactor 82, such that the conversion of the air 86 and of the predetermined calcium-based carrier 88 is then designed to be effected in the second circulating bed reactor 82. The predefined calcium-based output 84 and the specific solid carbonaceous fuel 78 are, in accordance with the fourth exemplary embodiment 74 of the mode of operation of the hot solids process of the present invention, which is schematically depicted in FIG. 5 of the drawings, designed to be supplied as inputs to the first circulating bed reactor 80. Within the first circulating bed reactor 80, the predefined calcium-based output 84 and the specific solid carbonaceous fuel 78 are then, in accordance with the fourth exemplary embodiment 74 of the mode of operation of the hot solids process 10 of the present invention, which is schematically depicted in FIG. 5 of the drawings, converted in order to thereby generate therefrom in the first circulating bed reactor 80 the pre-identified CO product 76, whereupon the pre-identified CO product 76 is thereafter designed to be suitably discharged from the first circulating bed reactor 80.

While preferred embodiments of the present invention have been shown and described in the instant application, it is to be understood that various modifications and substitutions may be made thereto without departing from the spirit and scope of the present invention as set forth in the claims that are appended hereto. Accordingly, it is to be further understood that the present invention, as the present invention has been described herein, has been described by way of illustration and not limitation.

What is claimed is:

1. A hot solids process operable selectively for combustion purposes and for gasification purposes comprising:
selecting a pre-identified product to be generated through the use of the hot solid process from a group of products that includes at least two or more of gaseous CO2, liquid CO2, CO/H2 syngas, gaseous H2, liquid H2, gaseous CO, and liquid CO;
selecting, based on the nature of the pre-identified product to be generated through the use of the hot solids process, a specific fuel from which the pre-identified product is capable of being derived from a group of fuels that includes at least two or more solid carbonaceous fuels, liquid carbonaceous fuels, petro waste refuse derived fuels, and biomass;
selecting from a group of reactors that includes at least two or more a fixed bed reactor, a bubbling bed reactor, a circulating bed reactor, a transport reactor, and an entrained bed reactor a first reactor operable for generating the pre-identified product as an output from the first reactor;
selecting from a group of reactors that includes at least two or more of a fixed bed reactor, a bubbling bed reactor, a circulating bed reactor, a transport reactor, and an entrained bed reactor a second reactor operable for effecting the conversion of air and a predetermined carrier selected from a group of carriers that includes calcium-based carriers and metal-based carriers to produce a predefined output from the second reactor;
supplying air and the predetermined carrier to the second reactor as inputs to the second reactor;
effecting the conversion of the air and of the predetermined carrier in the second reactor to produce the predefined output from the second reactor;
supplying the predefined output from the second reactor and the specific fuel to the first reactor as inputs to the first reactor;
effecting the conversion in the first reactor of the predefined output from the second reactor and of the specific fuel to generate the pre-identified product in the first reactor; and
effecting the discharge of the pre-identified product as an output from the first reactor.

2. The hot solids process as claimed in claim 1 further comprising selecting CO2 as the pre-identified product.

3. The hot solids process as claimed in claim 2 further comprising selecting a solid carbonaceous fuel as the specific fuel.

4. The hot solids process as claimed in claim 3 further comprising:
selecting a first circulating bed reactor as the first reactor; and
selecting a second circulating bed reactor as the second reactor.

5. The hot solids process as claimed in claim 4 further comprising:
selecting a calcium-based carrier as the predetermined carrier; and
effecting the conversion of the air and of the predetermined calcium-based carrier in the second circulating bed reactor to produce a predefined calcium-based output.

6. The hot solids process as claimed in claim 1 further comprising selecting CO/H2 syngas as the pre-identified product.

7. The hot solids process as claimed in claim 6 further comprising selecting a solid carbonaceous fuel as the specific fuel.

8. The hot solids process as claimed in claim 7 further comprising:
selecting a first circulating bed reactor as the first reactor; and
selecting a second circulating bed reactor as the second reactor.

9. The hot solids process as claimed in claim 8 further comprising:
selecting a calcium-based carrier as the predetermined carrier;
effecting the conversion of the air and of the predetermined calcium-based carrier in the second circulating bed reactor to produce a predefined calcium-based output.

10. The hot solids process as claimed in claim 1 further comprising selecting H2 as the pre-identified product.

11. The hot solids process as claimed in claim 12 further comprising selecting a solid carbonaceous fuel as the specific fuel.

12. The hot solids process as claimed in claim 13 further comprising:
selecting a first circulating bed reactor as the first reactor; and
selecting a second circulating reactor as the second reactor.

13. The hot solids process as claimed in claim 12 further comprising:
selecting a calcium-based carrier as the predetermined carrier; and
effecting the conversion of the air and of the predetermined calcium-based carrier in the second circulating bed reactor to produce a predefined calcium-based output.

14. The hot solids process as claimed in claim 1 further comprising selecting CO as the pre-identified product.

15. The hot solids process as claimed in claim 14 further comprising selecting a solid carbonaceous fuel as the specific fuel.

16. The hot solids process as claimed in claim 15 further comprising
selecting a first circulating bed reactor as the first reactor, and
selecting a second circulating bed reactor as the second reactor.

17. The hot solids process as claimed in claim 16 further comprising:
selecting a calcium-based carrier as the predetermined carrier; and
effecting the conversion of the air and of the predetermined calcium-based carrier in the second circulating bed reactor to produce a predefined calcium-based output.
